(19) United States
(12) Patent Application Publication
(10) Pub. No.: US 2026/0038725 A1
(43) Pub. Date: Feb. 5, 2026

(54) Passive Electrotechnical Component

(71) Applicant: WÜRTH ELEKTRONIK EISOS GMBH & CO., KG, Waldenburg (DE)

(72) Inventors: Robert Hartung, Krautheim (DE); Simon Mark, Weißbach (DE)

(21) Appl. No.: 18/997,633

(22) PCT Filed: Aug. 18, 2023
(86) PCT No.: PCT/EP2023/072803

§ 371 Date: Jan. 22, 2025

(30) Foreign Application Priority Data
Aug. 24, 2022 (DE) 10 2022 208 739.9

(51) Int. Cl. H01F 27/24; H01F 27/28

(52) U.S. Cl. CPC H01F 27/24; H01F 27/28

(57) ABSTRACT

The invention relates to a passive electrotechnical component for damping common mode and differential mode interference on at least two electrical lines leading to the component, with two toroidal cores, wherein at least two windings are arranged on each toroidal core, wherein the two windings on the first annular core are wound and/or interconnected in such a manner that high damping of common mode signals on the electrical lines is obtained, and wherein the windings on the second toroidal core are wound and/or interconnected in such a manner that high damping of differential mode interference on the electrical lines is obtained.

### FIELD OF THE INVENTION

The invention relates to a passive electrotechnical component.

German laid-open application DE 10 201 206 171 A1 discloses a separating element for a toroidal core choke. The separating element is constructed in two parts, and the first part can be latched into the second part.

Japanese patent abstract JP 03062506 A discloses a common mode choke.

A further common mode choke is disclosed in US laid-open application US 2008/0129438 A1.

### BACKGROUND

The invention is intended to improve a passive electrotechnical component.

### SUMMARY

According to the invention, a passive electrotechnical component with the features of claim 1 is provided for this purpose. Advantageous developments of the invention are mentioned in the dependent claims.

A passive electrotechnical component according to the invention is provided for damping common mode and differential mode interference on at least two electrical lines leading to the component and has two toroidal cores, wherein at least two windings are arranged on each toroidal core. The two windings on the first toroidal core are wound and/or interconnected in such a manner that high damping of common mode signals on the electrical lines is obtained. The windings on the second toroidal core are wound and/or interconnected in such a manner that high damping of differential mode interference on the electrical lines is obtained.

Common mode interference refers to interference having substantially the same signal level on at least two lines, via which a wanted or useful signal is also conducted. Consequently, common mode interference cannot be measured between the two lines. Furthermore, differential mode interference is known. Differential mode interference has a different voltage level on at least two lines on which a wanted or useful signal is also conducted. Consequently, differential mode interference can be measured between the two lines which also conduct the wanted or useful signal. Both common mode interference and differential mode interference impair the quality and usability of the wanted or useful signal. The passive electrotechnical component according to the invention permits the simultaneous damping of differential mode and common mode interference. The electrotechnical component according to the invention combines a common mode choke with a differential mode choke. The common mode choke has a first toroidal core on which two windings are arranged. The differential mode choke has a second toroidal core on which two windings are likewise arranged. The windings on the first toroidal core of the common mode choke are wound and/or interconnected in such a manner that the magnetic fluxes caused by the common mode interference on the different lines and therefore on the different windings accumulate in the toroidal core such that the common mode interference is thereby damped. The magnetic fluxes generated on the first toroidal core by the wanted or useful signal, on the other hand, cancel one another out, and therefore virtually no damping of the wanted or useful signal is caused. In the second toroidal core of the differential mode choke, the differential mode interference on the different lines and therefore on the different windings generates magnetic fluxes which mutually accumulate. As a result, differential mode interference is damped on the second toroidal core of the differential mode choke. The material of the second toroidal core is selected in such a manner that it becomes saturated only at a late point so as to avoid saturation of the second toroidal core during normal operation. The inductance of the differential mode choke has to be selected in such a manner that the wanted or useful signal is not too greatly damped, and instead only the differential mode interferences. This is possible because the differential mode interference and the wanted or useful signal lie in a different frequency range.

In a development of the invention, the first toroidal core is formed from ferrite, in particular from manganese-zinc ferrite.

As a result, high common mode damping can be obtained in the common mode choke.

In a development of the invention, the second toroidal core is formed from iron, in particular from iron powder.

A toroidal core made from iron or iron powder has high saturation. As a result, saturation of the differential mode choke during normal operation can be avoided, and therefore the inductance is of a sufficient size for damping the differential mode interference signal.

In a development of the invention, the two toroidal cores are arranged on a common base.

A very compact arrangement is thereby made possible.

In a development of the invention, the two toroidal cores are arranged parallel to each other and in such a manner that their through openings are aligned.

A very compact and space-saving arrangement is also obtained as a result.

In a development of the invention, the two toroidal cores have the same geometrical dimensions, and diameter and material of the winding wire used for all of the windings are identical, and/or the number of turns of all of the windings is identical.

The passive electrotechnical component according to the invention can thereby be produced cost-effectively in automated form in high piece numbers.

In a development of the invention, the passive electrotechnical component has two toroidal cores and a base on which the toroidal cores are arranged, wherein two windings which are separated spatially from each other are arranged on each toroidal core such that, on each toroidal core, a first winding is arranged on a first angular region of the toroidal core and a second winding is arranged on a second angular region of the toroidal core, wherein the first and the second angular regions are different from each other and do not overlap, wherein a holding and separating element is provided which, on the one hand, is connected to the base and, on the other hand, engages in the interior of each toroidal core, wherein the holding and separating element is formed integrally, wherein the holding and separating element has two separating portions, wherein a first separating portion lies against at least two spaced-apart contact points on the inner circumference of the first toroidal core and, as a result, on the inner circumference of the first toroidal core, separates the first angular region for the first winding on the toroidal core and the second angular region for the second winding on the first toroidal core from each other, and wherein a second separating portion lies against at least two spaced-apart contact points on the inner circumference of the second toroidal core and, as a result, on the inner circumference of the second toroidal core, separates the first angular region for the first winding on the second toroidal core and the second angular region for the second winding on the second toroidal core from each other.

By means of a single holding and separating element, the two toroidal cores can thereby be held in position on the base and the two windings on the first toroidal core can be separated from each other. Furthermore, the two windings on the second toroidal core can also be separated from each other by means of the holding and separating element. The passive electrotechnical component according to the invention is thereby also suitable for network applications with a voltage of, for example, 250 V. This is because the separation of the two windings on the first toroidal core and the separation of the two windings on the second toroidal core reliably avoid a short circuit between the two windings on the first toroidal core and the two windings on the second toroidal core. This is true even if the component is exposed to severe accelerations or vibration.

In a development of the invention, the two toroidal cores are arranged parallel to each other, wherein a contact portion of the holding and separating element is arranged between a first side surface of the first toroidal core and a second side surface of the second toroidal core, which faces the first side surface of the first toroidal core, and wherein the first side surface of the first toroidal core and the second side surface of the second toroidal core lie against the contact portion.

By means of the holding and separating element, the two toroidal cores can thereby be held at an exactly defined distance from each other since both the first toroidal core and the second toroidal core lie against the contact portion of the holding and separating element.

In a development of the invention, the holding and separating element is plate-like.

In this way, the holding and separating element can be produced cost-effectively and the elastic properties of the holding and separating element can be defined by simple incisions or cutouts in the holding and separating element.

In a development of the invention, at least the separating portions of the holding and separating element are elastically deformable.

In this way, the separating portions can be, for example, compressed and introduced into the toroidal cores. After they are released, the separating portions then spring back again and thereby lie securely against a first contact point and against the second contact point on the inner circumference of the toroidal core. For example, the separating portions can be clipped into the interior of the toroidal core.

In a development of the invention, the separating portions are each provided with at least one incision which extends from a border of the holding and separating element into the separating portion.

An elasticity of the separating portion can thereby be set depending on the length of the incision.

In a development of the invention, the two separating portions are connected to each other, and an elongate cutout/through opening extends from the first separating portion into the second separating portion.

The elastic deformability of the two separating portions can thereby also be set.

In a development of the invention, each separating portion is provided with two incisions which extend from a border of the separating portion rectilinearly in the direction of the opposite separating portion into the separating portion, and the elongate cutout/through opening is arranged parallel to the two incisions.

In this way, two resilient latching arms are formed on each separating portion, which latching arms, upon being pushed into the interior of a toroidal core, can then first of all be deflected and can spring back again after reaching the designated final position.

In a development of the invention, a free end of the separating portions is provided with at least one latching lug in each case in order to grip behind a side surface of the respective toroidal core.

In this way, the holding and separating element can be latched into the inner circumference of a toroidal core.

In a development of the invention, the free end of each separating portion is provided with two opposite latching lugs in order to grip behind the side surface of the respective toroidal core at two opposite points.

In this way, each separating portion can simply be compressed to such an extent, in order to be inserted into a toroidal core, that the distance between the two opposite latching lugs is somewhat smaller than the inside diameter of the toroidal core. After the insertion and when the latching lugs have completely traversed the interior of the toroidal core, the latching lugs can spring back again radially outwards and can thereby securely fix the separating portion in the toroidal core.

In a development of the invention, the holding and separating element is inserted with a foot portion into a cutout in the base.

The holding and separating element can thereby be fixed in a very simple manner to the base.

In a development of the invention, the holding portion is elastically deformable.

The holding and separating element can thereby be fastened in a very simple manner and reversibly to the base. For example, the two toroidal cores in the fully wound state are latched onto the separating portions of the holding and separating element and then the holding and separating element is fastened with its foot portion to the base. This can take place in each case without a tool and optionally in fully automated form.

In a development of the invention, the holding portion is provided with at least one incision which extends from a border of the holding and separating element into the holding portion.

In this way, elastic deformability of the holding portion can be ensured, in particular in the case of a plate-like holding and separating element.

In a development of the invention, the holding and separating element is designed as a plastics injection-moulded part.

In this way, cost-effective production in large piece numbers is easily possible. The plastic which is used should have the desired electrically insulating properties.

In a development of the invention, the base is provided with incisions emanating from side surfaces of the base, in order to guide winding wires to an underside of the base.

In this way, the winding wires do not have to protrude beyond the contour of the base. The handling of the passive component according to the invention is thereby facilitated and in particular the winding wires are thereby arranged in protected form.

In a development of the invention, an underside of the base facing away from the toroidal cores is provided with contact surfaces or contact pins.

For example, an underside of the base is provided with contact surfaces and is in the form of an SMD part. The winding wires are then led to the contact surfaces and electrically connected thereto. Alternatively, contact pins can also be provided on the underside of the base, the contact pins then likewise being electrically connected to the winding wires.

### BRIEF DESCRIPTION OF THE DRAWINGS

Further features and advantages of the invention emerge from the claims and the description below of a preferred embodiment of the invention in conjunction with the drawings. In the drawings:

FIG. 1 shows the schematic electrical design of the passive component according to the invention,

FIG. 2 shows a view of the passive component according to the invention obliquely from above,

FIG. 3 shows a first sectional view of the component from FIG. 2,

FIG. 4 shows a second sectional view of the component from FIG. 2,

FIG. 5 shows a view obliquely from the front of the holding and separating element of the passive component according to the invention from FIG. 2,

FIG. 6 shows a front view of the holding and separating element from FIG. 5, and

FIG. 7 shows a view of the passive electrotechnical component from FIG. 2 obliquely from below.

### DETAILED DESCRIPTION

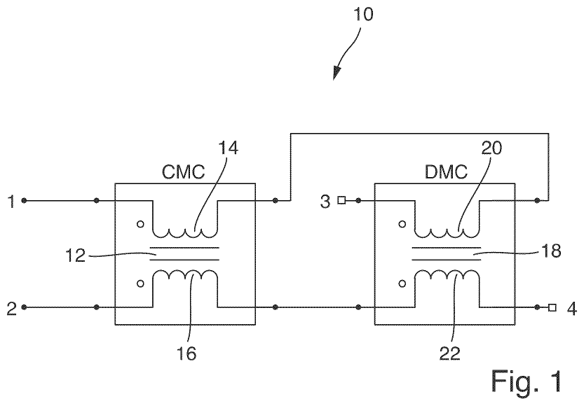

FIG. 1 shows the schematic electrical design of the passive component according to the invention. The component according to the invention has a common mode choke CMC (Common mode choke) and a differential mode choke DMC (Differential mode choke). The common mode choke CMC is provided for damping common mode signals on the electrical lines 1, 2 which lead to the passive component 10 according to the invention. The two lines can then be led further from the terminals 3, 4 on.

Common mode interference on the two lines 1, 2 refers to signals which have substantially the same voltage on the two lines 1, 2. Common mode interference arises, for example, by the fact that the two lines 1, 2, in each case as seen by themselves, act as antennae. Common mode interference on the lines 1, 2 cannot be determined by means of a measurement between the two lines 1, 2 since they have substantially the same voltage or the same potential on both lines 1, 2.

The common mode choke CMC has a schematically illustrated toroidal core 12 and a first winding 14 and a second winding 16 on the first toroidal core 12. The two windings 14, 16 are wound onto the toroidal core 12 in such a manner that the magnetic flux which is caused by the common mode interference on the line 1 in the first toroidal core 12 and the magnetic flux which is caused by the common mode interference on the line 2 in the first toroidal core 12 are accumulated. As a result, the electrical energy of the common mode interference is converted into magnetic energy and then damped in the first toroidal core 12. The first toroidal core 12 is composed of ferrite. Manganese-zinc ferrite has proven advantageous within the context of the invention.

The two windings 14, 16 on the first toroidal core 12 have the same number of turns and also consist of the same wire with the same thickness and the same ohmic resistance. The two windings 14, 16 are wound on the toroidal core 12 with the same winding direction, and therefore, in the event of common mode signals, the magnetic fluxes generated by the two windings 14, 16 accumulate in the toroidal core 12.

Alternatively, the two windings 14, 16 on the first toroidal core 12 can also have a different winding direction. In this case, however, the common mode choke CMC then has to be connected differently to the two lines 1, 2 in order again to achieve the fact that the magnetic flux generated by the common mode interference on the two lines 1, 2 accumulates in the first toroidal core 12. This could take place, for example, by the line 1 not being connected to that terminal of the common mode choke CMC which is at the top left in FIG. 1, but rather to that terminal of the common mode choke CMC which is at the top right in FIG. 1.

If a wanted or useful signal is transported on the two lines 1, 2, said wanted or useful signal has a potential difference between the two lines 1, 2. The wanted or useful signal can therefore be measured between the two lines 1, 2. If a wanted or useful signal now impinges on the common mode choke CMC via the two lines 1, 2, the magnetic fluxes of the magnetic fluxes generated in the two windings 4, 16 by the wanted or useful signal cancel one another out. The wanted or useful signal is thus virtually not damped by the common mode choke CMC.

The component 10 according to the invention furthermore has a differential mode choke DMC (Different mode choke). The differential mode choke DMC has a second toroidal core 18, a first winding 20 on the second toroidal core 18, and a second winding 22 on the second toroidal core 18. The windings 20, 22 are wound on the second toroidal core 18 in the same way as the two windings 14, 16 on the first toroidal core 12. In order to obtain the effect of a differential mode choke DMC, the output of the first winding 14 on the first toroidal core 12, i.e. the terminal point positioned at the top right in FIG. 1, is, however, connected to the terminal point positioned on the top right side of the differential mode core DMC in FIG. 1. By contrast, the output at the bottom right of the common mode choke CMC is connected to that terminal of the differential mode choke DMC which is located at the bottom left.

In other words, the signal which has passed through the common mode choke CMC is conducted in a reverse direction through the first winding 20 on the second toroidal core 18, whereas the signal coming from the common mode choke CMC is conducted in the same direction as in the common mode choke CMC through the second winding 22 of the differential mode choke DMC. This leads to the fact that the magnetic fluxes of a differential mode signal which is conducted through the first winding 20 and the second winding 22 on the second toroidal core 18 accumulate on the second toroidal core 18. As a result, differential mode interference on the two lines is damped in the differential mode choke DMC.

Differential mode interference refers to a signal which has a potential difference between the two lines 1, 2. Since this is also the case for the wanted or useful signal on the two lines 1, 2, the differential mode choke DMC has to be dimensioned in such a manner that it is primarily differential mode interference and not the wanted or useful signal which is damped. This is possible by suitable determination of the inductance of the two windings 20, 22 on the second toroidal core 18 since the differential mode interference generally has a different frequency from the wanted or useful signal. As a result of the second toroidal core 18 consisting of iron, specifically being produced from iron powder, the material of the second toroidal core 18 is saturated only in the case of large magnetic fluxes. Saturation of the second toroidal core 18 can thereby be avoided during normal operation, and therefore the inductance is of a sufficient size for damping the differential mode interference.

The two lines 3, 4 lead away from the component 10 according to the invention. There is essentially only still the wanted or useful signal on the two lines 3, 4 since common mode interference is damped in the common mode choke CMC and differential mode interference is damped in the differential mode choke DMC.

The two windings 20, 22 on the second toroidal core 18 have the same number of turns and consist of the same wire with the same thickness and the same ohmic resistance. In the case of the component 10 according to the invention, the windings 14, 16 on the first toroidal core 12 and the windings 20, 22 on the second toroidal core 18 consist of the same winding wire with the same diameter and the same ohmic resistance and all of them have the same number of turns too.

As will also be explained below, the windings 14, 16 on the first toroidal core 12 and the windings 20, 22 on the second toroidal core 18 are arranged spatially separated from one another on the first toroidal core 12 and on the second toroidal core 18, respectively. As a result, the component 10 according to the invention is also readily suitable for network applications with voltages of, for example, 250 V. This is achieved by the fact that the first winding 14 is wound on a different angular region of the first toroidal core 12 from the second winding 16. The first winding 20 on the second toroidal core 18 is wound on a different angular region of the second toroidal core 18 from the second winding 22. The different angular regions do not overlap.

In order to ensure the spatial and electrical separation of the windings 14, 16 on the first toroidal core 12 and the windings 20, 22 on the second toroidal core 18, use is made of a holding and separating element which will also be explained below.

With the component 10 according to the invention a passive electrotechnical component is provided with which both common mode interference and differential mode interference can be damped.

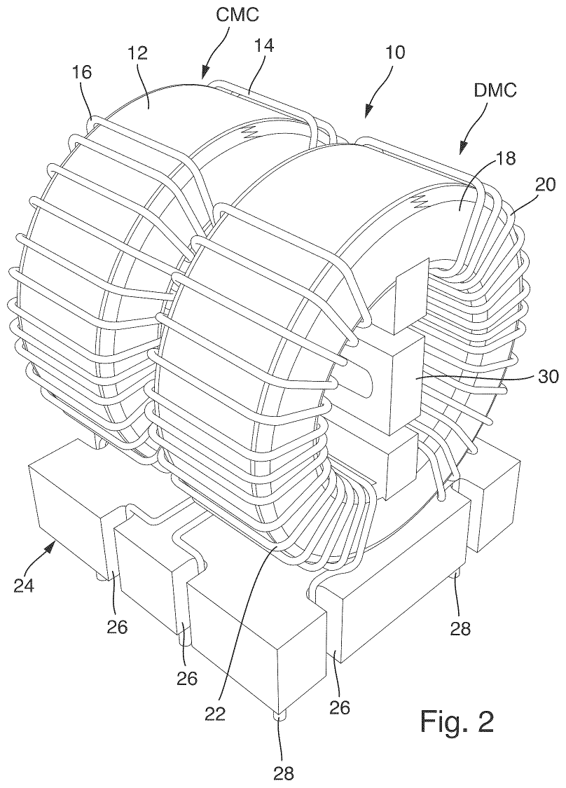

FIG. 2 shows a view of the passive component 10 according to the invention in a view obliquely from above.

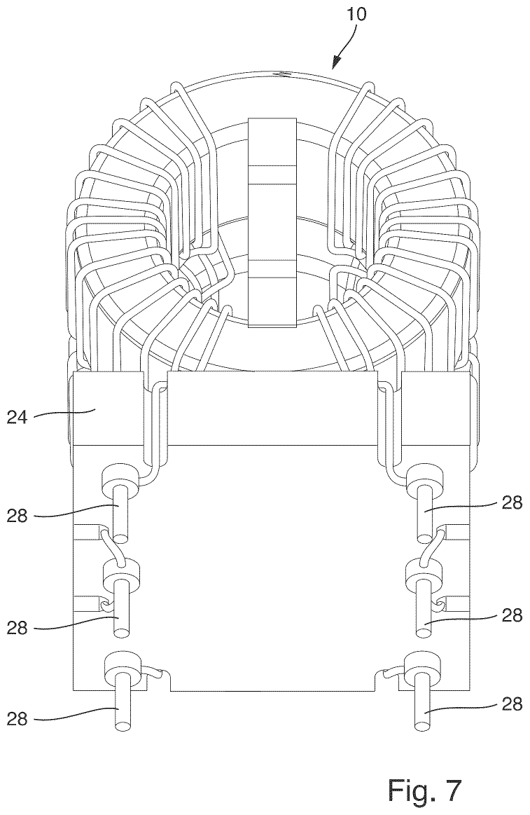

The passive component 10 according to the invention has the common mode choke CMC and the differential mode choke DMC. The common mode choke CMC and the differential mode choke DMC are arranged next to each other on a base 24. The base 24 is designed to be cuboidal in the form of a thick plate. The base 24 is provided at its side edges with a plurality of incisions 26 through each of which a winding wire is guided onto the underside of the base 24. A plurality of contact pins 28 are arranged on the underside of the base 24, the underside being concealed in FIG. 2, the contact pins being connected in turn to one winding wire each, also see FIG. 7.

The common mode choke CMC has the first toroidal core 12 which, in the illustrated embodiment, is composed of ferrite. In the embodiment which is illustrated, the first toroidal core 12 is composed of manganese-zinc ferrite. The first winding 14 and the second winding 16 are wound onto the first toroidal core 12. The first winding 14 and the second winding 16 are separated from each other by the fact that they are wound onto different angular regions of the first toroidal core 12, with said angular regions not overlapping.

The differential mode choke DMC has the second toroidal core 18 which is formed from iron, in the illustrated embodiment from iron powder. The second toroidal core 18 has the same geometrical dimensions as the first toroidal core 12. The two toroidal cores 12, 18 are arranged on the base 24 in such a manner that their central axes are arranged in alignment with each other.

The first winding 20 and the second winding 22 are wound on the second toroidal core 18 of the differential mode choke DMC. The first winding 20 and the second winding 22 are wound onto angular regions differing from each other of the second toroidal core 18, said angular regions not overlapping.

By means of the winding onto different angular regions, the first winding 14 and the second winding 16 on the first toroidal core 12 are spatially separated from each other and the first winding 20 and the second winding 22 on the second toroidal core 18 are likewise spatially separated from each other. In order to prevent the wires of the first winding 14 and of the second winding 16 on the first toroidal core 12 and the wires of the first winding 20 and of the second winding 22 on the second toroidal core 18 from coming into contact with one another, a holding and separating element 30 is additionally also provided. The holding and separating element 30 extends both into the interior of the first toroidal core 12 and into the interior of the second toroidal core 18 and lies against two mutually opposite contact points on the inner circumference of the first toroidal core 12 and against two opposite contact points on the inner circumference of the second toroidal core 18. Even if the component 10 according to the invention is exposed to high accelerations or vibrations, for example during use in a vehicle, the windings 14, 16, 20, 22 cannot slip on the respective annular core 12, 18 to such an extent that wires of different windings come into contact with one another. The passive component 10 is thereby also suitable for network applications with voltages of, for example, 250 V or more.

The holding and separating element 30 also holds the two toroidal cores 12, 18 in position with respect to each other and also in position with respect to the base 24. This is also explained below.

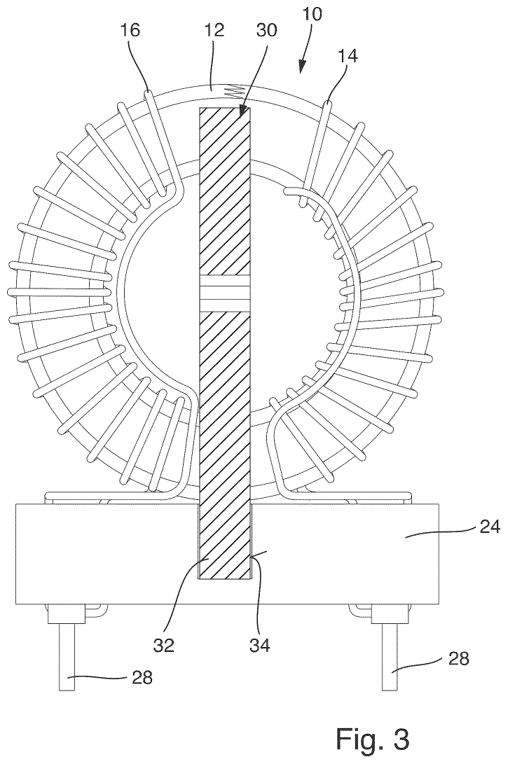

FIG. 3 shows a sectional view of the component 10 according to the invention. In FIG. 2, the sectional plane runs between the first toroidal core 12 and the second toroidal core 18, and therefore, when looking at said sectional plane according to FIG. 3, only the first toroidal core 12 with the first winding 14 and the second winding 16 can be seen. The holding and separating element 30 is illustrated in sectioned form. A holding portion 32 of the holding and separating element 30 is arranged in a blind hole in the base 24. The holding portion 32 is clamped into the blind hole 34 in the base.

In the view of FIG. 3, two contact pins 28 which are connected to winding wires can be seen on the underside of the base 24.

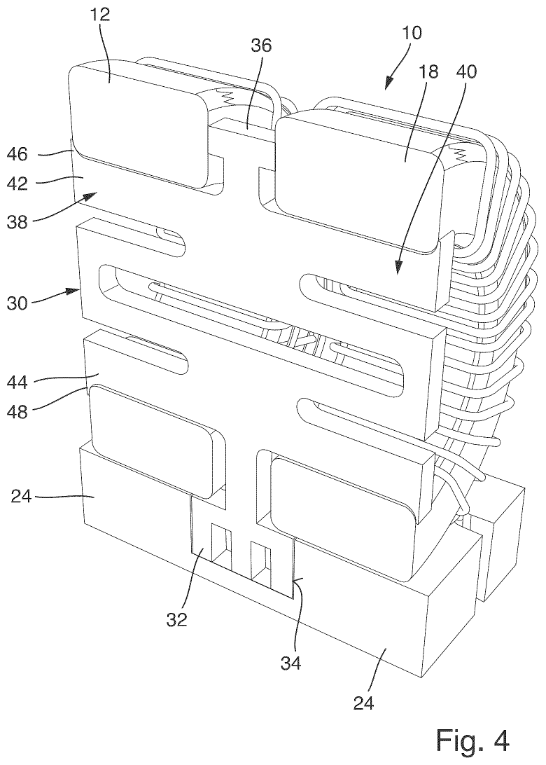

FIG. 4 shows a further sectional view of the component 10 according to the invention, wherein the sectional plane in the view of FIG. 4 contains the central axis of the first toroidal core 12 and of the second toroidal core 18. In the sectional view of FIG. 4, the first toroidal core 12, the second toroidal core 18 and the base 24 can be seen, and the holding and separating element 30 is cut through in the centre parallel to its side surfaces.

The holding portion 32 of the holding and separating element 30, which holding portion is clamped in the blind hole 34 in the base 24, has already been explained. For this purpose, the holding portion 32 is fork-shaped and has two incisions. The two portions of the holding portion 32 that are arranged on the left and right in FIG. 4 can thereby be elastically deformed inwards somewhat. As a result, the clamping effect in the cutout 34 is achieved. Within the scope of the invention, the holding portion 32 can, of course, also be adhesively bonded in the cutout 34 or welded in a suitable manner to the wall of the cutout 34. The holding and separating element 30 can be designed as a plastics injection-moulded part.

It can furthermore be seen in FIG. 4 that the holding and separating element has a contact portion 36 which is T-shaped. The first toroidal core 12 and the second toroidal core 18 lie against the two end faces of the transverse bar of the contact portion 36. The two toroidal cores 12, 18 are therefore held at a defined distance from each other by means of the contact portion 36.

A first separating portion 38 of the holding and separating element extends into the interior of the first toroidal core 12. A second separating portion 40 of the holding and separating element 30 extends into the interior of the second toroidal core 18. Each of the separating portions 38, 40 is elastically deformable to the extent that, in the illustration of FIG. 4, the separating portion 38 can be compressed somewhat from the top downwards and the separating portion 40 can likewise be compressed somewhat in the direction from the top downwards.

It can be seen in FIG. 4 that, in the region of the separating portion 38, an upper latching arm 42 lies against the inner circumference of the first toroidal core 12 and a lower latching arm 44 likewise lies against the inner circumference of the toroidal core 12. The latching arm 42 has a latching lug 46 extending away upwards from the base in FIG. 4. The latching arm 44 located at the bottom in FIG. 4 has a latching lug 48 extending towards the base 24, i.e. downwards in FIG. 4. If the separating portion 38 is pushed into the inner circumference of the first toroidal core 12, first of all the two latching arms 42, 44 are moved somewhat towards each other until the latching lugs 46, 48 lie against the inner circumference of the first toroidal core 12 at opposite contact points. The separating portion 38 is then pushed parallel to the central axis of the first toroidal core 12 into the interior thereof until the latching lugs 46, 48 again leave the interior of the first toroidal core 12 and are moved radially outwards into the position illustrated in FIG. 4. As a result, the latching arms 42, 44 snap radially outwards and the toroidal core 12 is then fixed in the position illustrated in FIG. 4 relative to the holding and separating element 30. This is a result of the fact that the toroidal core 12 cannot move to the left in FIG. 4 since this movement is prevented by the latching lugs 46, 48. The first toroidal core 12 also cannot move to the right in FIG. 4 since it is prevented from moving in this direction by the contact portion 36 of the holding and separating element 30.

In the same way, the separating portion 40 is moved into the interior of the second toroidal core 18 until the position of FIG. 4 is reached. The separating portion 40 is designed in the same manner as the separating portion 38. The second toroidal core 18 is held in its position relative to the holding and separating element of FIG. 4 by the fact that the latching lugs on the latching arms of the separating portion 40 prevent a movement outwards, i.e. to the right in FIG. 4, and the contact portion 36 prevents a movement of the toroidal core 18 towards the first toroidal core, i.e. to the left in FIG. 4. The two toroidal cores 12, 18 rest on the top side of the base 24 and are prevented by the holding and separating element 30 from moving away from the surface of the base.

It can also be seen in FIG. 4 that the holding and separating element 30 separates the windings on the toroidal cores 12 and 18 from each other and prevent the winding wires of the windings from touching one another if they are, for example, displaced relative to the toroidal cores 12, 18.

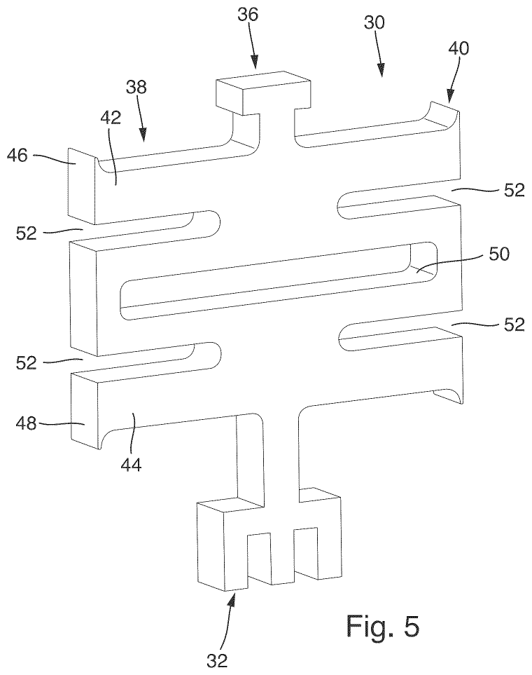

FIG. 5 shows the holding and separating element 30 in a view obliquely from the front. The holding portion 32 which is inserted into the cutout 34 in the base 24 can be seen, see FIG. 4. Furthermore, the contact portion 36, against the transverse bar of which the inner sides of the two toroidal cores 12, 18 lie, can be seen, see FIG. 4. The two latching arms 42, 44 can be seen on the separating portion 38 on the left in FIG. 5, wherein the latching arm 42 has the latching lug 46, which is directed away from the holding portion 32, and the latching arm 44 has the latching lug 48, which faces the holding portion 32. The latching lugs 46, 48 prevent the first toroidal core 12 from moving away from the holding and separating element 30.

The separating portion 40 lies opposite the separating portion 38 and is constructed symmetrically with respect to the separating portion 38, wherein the plane of symmetry runs centrally through the contact portion 36 and the holding portion 32.

An oval cutout 50 which extends into the separating portion 38 and the separating portion 40 can be seen between the contact portion 36 and the holding portion 32. Together with the incisions 52 which run parallel to the cutout 50, the cutout 50 ensures elastic deformability of the separating portions 38, 40, and therefore the latching arms 42, 44 of the separating portion 38 and the latching arms of the separating portion 40 can move towards each other during the insertion into the interior of the toroidal cores 12, 18 and can then spring back again after traversing the interior, see FIG. 4.

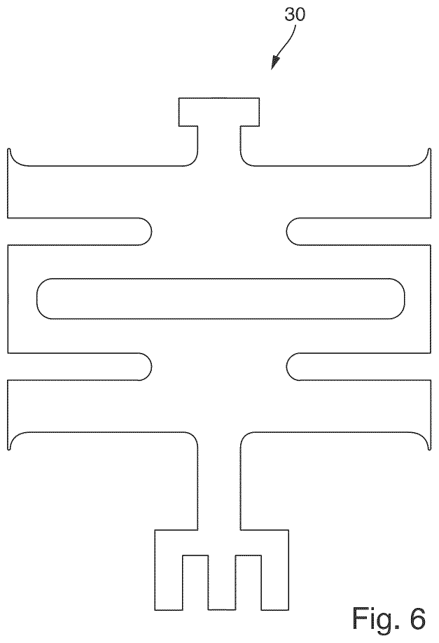

FIG. 6 shows a top view of the holding and separating element 30 in FIG. 5.

FIG. 7 shows the passive component 10 according to the invention in a view obliquely from below. On the underside of the base 24 a total of six contact pins 28 can be seen which can be inserted, for example, into matching through openings in a printed circuit board. The lines 1, 2, 3, 4 can then be connected to the contact pins 28, see FIG. 1. The winding wires of in each case two windings are connected to the central contact pins 28 in FIG. 7 in order to realize the interconnection, illustrated schematically in FIG. 1, of the common mode choke CMC and the differential mode choke DMC.

1. A passive electrotechnical component for damping common mode and differential mode interference on at least two electrical lines leading to the passive component, comprising:
two toroidal cores,
wherein at least two windings are arranged on each toroidal core,
wherein the two windings on the first toroidal core are wound and/or interconnected in such a manner that high damping of common mode signals on the electrical lines is obtained, and
wherein the windings on the second toroidal core are wound and/or interconnected in such a manner that high damping of differential mode interference on the electrical lines is obtained.

2. The passive electrotechnical component according to claim 1, wherein the first toroidal core is formed from ferrite, in particular from manganese-zinc ferrite.

3. The passive electrotechnical component according to claim 1, wherein the second toroidal core is formed from iron, in particular from iron powder.

4. The passive electrotechnical component according to claim 1, wherein the two toroidal cores are arranged on a common base.

5. The passive electrotechnical component according to claim 1, wherein the two toroidal cores are arranged parallel to each other and in such a manner that their through openings are aligned.

6. The passive electrotechnical component according to claim 1, wherein the two toroidal cores have the same geometrical dimensions, in that diameter and material of the winding wire used for all of the windings are identical, and/or in that the number of turns of all of the windings is identical.

7. The passive electrotechnical component according to claim 1, with the two toroidal cores having a base on which the toroidal cores are arranged, wherein two windings which are separated spatially from each other are arranged on each toroidal core such that, on each toroidal core, a first winding is arranged on a first angular region of the toroidal core and a second winding is arranged on a second angular region of the toroidal core, wherein the first and the second angular regions are different from each other and do not overlap, wherein a holding and separating element is provided which, on the one hand, is connected to the base and, on the other hand, engages in the interior of each toroidal core, wherein the holding and separating element is formed integrally, wherein the holding and separating element has two separating portions, wherein a first separating portion lies against at least two spaced-apart contact points on the inner circumference of the first toroidal core and, as a result, on the inner circumference of the first toroidal core, separates the first angular region for the first winding on the toroidal core and the second angular region for the second winding on the first toroidal core from each other, and wherein a second separating portion lies against at least two spaced-apart contact points on the inner circumference of the second toroidal core and, as a result, on the inner circumference of the second toroidal core, separates the first angular region for the first winding on the second toroidal core and the second angular region for the second winding on the second toroidal core from each other.

8. The passive component according to claim 7, wherein the two toroidal cores are arranged parallel to each other, wherein a contact portion of the holding and separating element is arranged between a first side surface of the first toroidal core and a second side surface of the second toroidal core, which faces the first side surface of the first toroidal core, and wherein the first side surface of the first toroidal core and the second side surface of the second toroidal core lie against the contact portion.

9. The passive component according to claim 7, wherein the holding and separating element is plate-like.

10. The passive component according to claim 7, wherein at least the separating portions of the holding and separating element are elastically deformable.

11. The passive component according to claim 10, wherein the separating portions are each provided with at least one incision which extends from a border of the holding and separating element into the separating portion.

12. The passive component according to claim 7, wherein the two separating portions are connected to each other, and an elongate cutout/through opening extends from the first separating portion into the second separating portion.

13. The passive component according to claim 11, wherein each separating portion is provided with two incisions which extend from a border of the separating portion rectilinearly in the direction of the opposite separating portion into the separating portion, and in that the elongate cutout/through opening is arranged parallel to the two incisions.

14. The passive component according to claim 7, wherein a free end of the separating portions is provided with at least one latching lug in each case in order to grip behind a side surface of the respective toroidal core.

15. The passive component according to claim 14, wherein the free end of each separating portion is provided with two opposite latching lugs in order to grip behind the side surface of the respective toroidal core at two opposite points.

16. The passive component according to claim 7, wherein the holding and separating element is inserted with a holding portion into a cutout in the base.

17. The passive component according to claim 16, wherein the holding portion is elastically deformable.

18. The passive component according to claim 17, wherein the holding portion is provided with at least one incision which extends from a border of the holding and separating element into the holding portion.

19. The passive component according to claim 7, wherein the holding and separating element is designed as a plastics injection-moulded part.

20. The passive component according to claim 1, wherein the base is provided with incisions emanating from side surfaces of the base, in order to guide winding wires to an underside of the base.

21. The passive component according to claim 1, wherein an underside of the base facing away from the toroidal cores is provided with contact surfaces or contact pins.
